(19) United States
(12) Patent Application Publication
(10) Pub. No.: US 2014/0039978 A1
(43) Pub. Date: Feb. 6, 2014

(54) SYSTEMS AND METHODS FOR ANALYZING FORECASTS AND RESPONSES IN COLLABORATIVE INVENTORY MANAGEMENT SETTINGS

(71) Applicants: Burcu AYDIN, Mountain View, CA (US); James MARRON, Durham, NC (US)

(72) Inventors: Burcu AYDIN, Mountain View, CA (US); James MARRON, Durham, NC (US)

(21) Appl. No.: 13/563,679

(22) Filed: Jul. 31, 2012

(51) Int. Cl. G06Q 10/08; G06Q 10/04

(52) U.S. Cl. 705/7.31

(57) ABSTRACT

A collaborative inventory management forecast and response analysis system includes a forecast and response summary engine and a display engine. The forecast and response summary engine is to generate a summary of a plurality of standardized forecast input series using continuum canonical correlation and a user-provided parameter, generate a summary of a plurality of standardized response input series using continuum canonical correlation and the user-provided parameter, and update the summaries of the plurality of standardized forecast and response series based on a varied value of the user-provided input parameter. The display engine is to display the summaries of the plurality of standardized forecast and response series and display the updated summaries of the plurality of standardized forecast and response series.

### BACKGROUND

In collaborative inventory management relationships, buyers and suppliers communicate with each other through forecasts and responses. Forecasts reflect what the buyer plans to purchase in the future and responses reflect what the supplier expects to supply in the future. Forecasts and responses may reflect a number of items or may be generated on an item-by-item basis.

Forecasts and responses may be generated using a rolling horizon method, where forecasts and responses are updated for a number of periods that extends to a horizon. For example, assume a horizon of eight weeks and periods of one week. In this example, a forecast and response for each of the next eight weeks is generated weekly. A large amount of forecast and response data is created since a forecast will have been generated for a period in time, for example the present, in each of the eight previous weeks. This large amount of data is compounded when considering that the horizon may be much greater than eight weeks or that the period may be less than one week.

### BRIEF DESCRIPTION OF THE DRAWINGS

The patent or application file contains at least one drawing executed in color. Copies of this patent or patent application publication with color drawings will be provided by the Office upon request and payment of the necessary fee.

For a detailed description of exemplary embodiments of the invention, reference will now be made to the accompanying drawings in which:

FIG. 1 shows an example of a number of forecast and response input series in accordance with various examples of the present disclosure;

FIG. 2 shows a block diagram of a collaborative inventory management forecast and response analysis system in accordance with various examples of the present disclosure;

FIG. 3 shows another block diagram of a collaborative inventory management forecast and response analysis system in accordance with various examples of the present disclosure;

FIG. 4 shows a standardized version of the input series of FIG. 1 in accordance with various examples of the present disclosure;

FIGS. 5a-5b show various example graphs of summary vectors F* and R* selected to maximize variation;

FIGS. 6a-6b show various example graphs of summary vectors F* and R* selected to maximize correlation; and

FIG. 7 shows a method flow chart in accordance with various examples of the present disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

As used herein, the term “horizon” refers to an amount of time in the future for which forecasts and responses are presently generated. For example, a horizon of three months means that a presently-generated forecast will include forecasts for each period within the next three months.

As used herein, the term “period” refers to a time interval for forecast and response generation. For example, a period of one week means that a forecast will be generated weekly and will include forecasts for each week extending to the horizon.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As explained above, analyzing previous forecast and responses is important in the context of collaborative inventory management to improve the accuracy of future forecasts and to be able to troubleshoot any inconsistencies that arise between buyer and supplier. Forecasts and responses may be viewed as a number of input series, with each input series including, for example, a forecast value for a number of periods generated from a fixed amount of time relative to each period. The large amount of forecast and response data generated by the rolling horizon method makes it particularly difficult to analyze past forecasts to determine meaningful information that may identify areas in which the collaborative inventory management relationship may be improved.

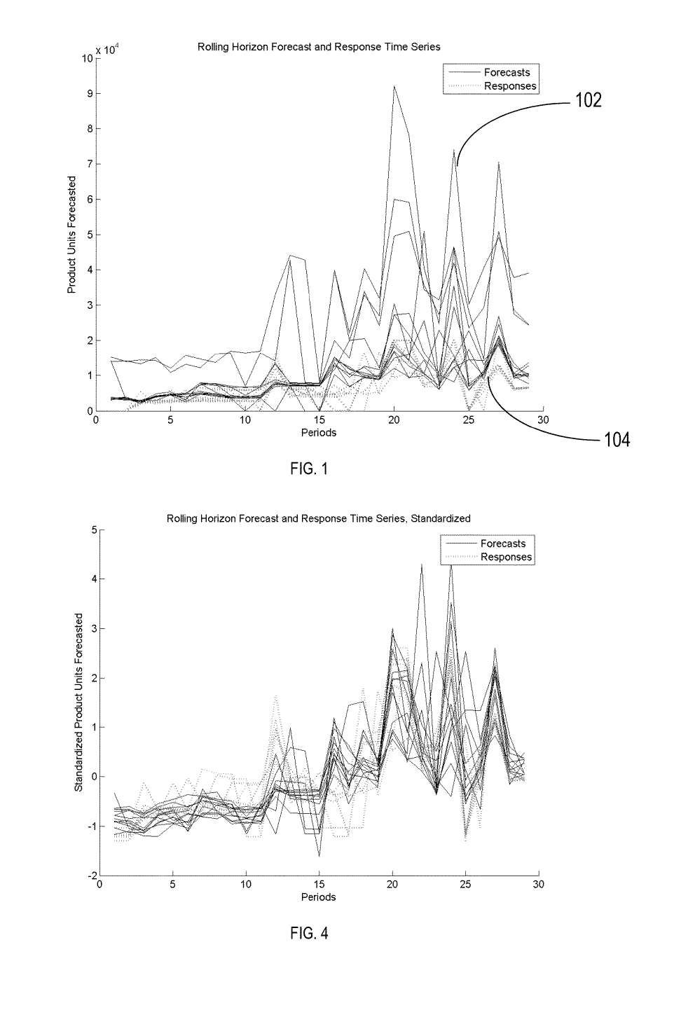

FIG. 1 shows an example of a number of forecast and response input series. The solid black lines represent forecast input series and the dotted lines represent response input series. A single input series shows a forecast or response for each period being analyzed (in this case, 30 periods) from n periods out. Thus, as an example, a single input series shows a forecast for each period from one period out (i.e., the forecast for period 2 is that generated in period 1, the forecast for period 10 is that generated in period 9, etc.). As another example, assuming that forecasts are never updated (i.e., the forecasts for a certain period do not change), all forecast input series would lay on top of each other on the graph. Typically, however, forecasts are routinely updated to take various business events into account, and the resulting view of the various forecast and response input series is as shown in FIG. 1. The horizon and period length often result in a large number of forecast and response input series, which may be difficult to view and analyze, as is evidenced in FIG. 1.

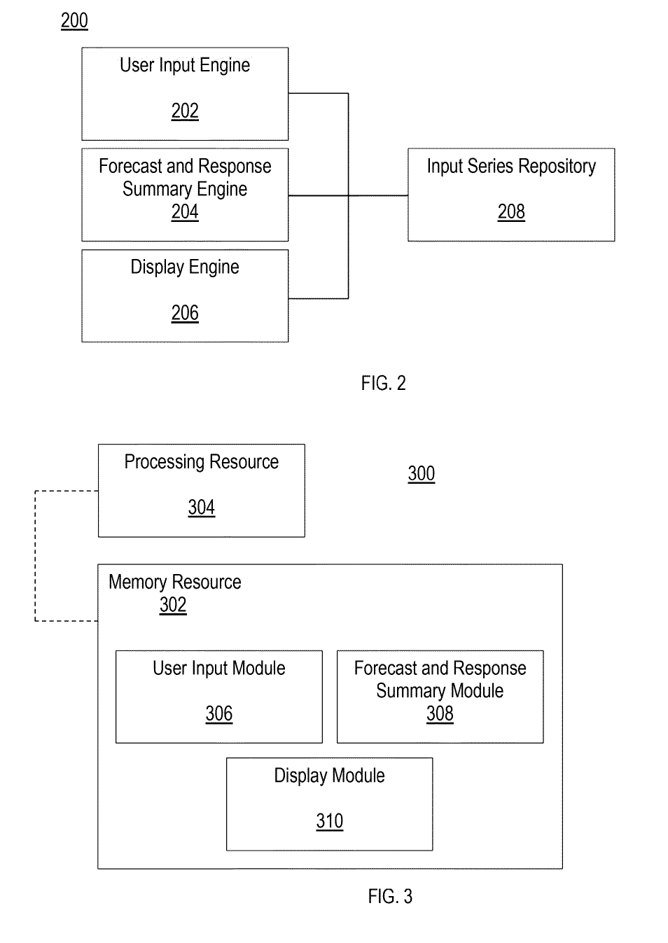

Turning now to FIG. 2, a collaborative inventory management forecast and response analysis system 200 is shown in accordance with various implementations. The collaborative inventory management forecast and response analysis system 200 includes a user input engine 202, a forecast and response summary engine 204, and a display engine 206. In addition, an input series repository 208 may be coupled to the engines 202, 204, 206. The user input engine 202, forecast and response summary engine 204, and display engine 206 are combinations of programming and hardware to execute the programming. Although shown separately, the user input engine 202, forecast and response summary engine 204, and display engine 206 are not required to represent separate pieces of software programming. For example, each engine 202, 204, 206 may share a common processor and memory, although this is not required. Additionally, the programming that enables the functionality of each engine 202, 204, 206 may be included in the same executable file or library.

The user input engine 202 receives a user-provided input parameter, which is to be applied to a continuum canonical correlation (CCC) analysis of forecast and response input series to generate a summary of those series. The specifics of CCC analysis will be discussed in further detail below. In some cases, the user-provided input parameter varies from 0 to 1, inclusive, and may be provided by way of a graphical user interface. The user input engine 202 also receives a varied value of the user-provided input parameter. For example, a slide bar, plus/minus symbols, or a field for direct entry of a value may be provided to the user, which allows the user to change the parameter value to alter the CCC analysis.

The input series repository 208 may store a number of forecast and response input series, such as those shown in FIG. 1. Additionally, the input series repository 208 may store standardized versions of the forecast and response input series, which will be described in further detail below. The forecast and response summary engine 204 may access the standardized forecast and response input series and the user-provided parameter from the user input engine 202. The forecast and response summary engine 204 generates a summary of a plurality of standardized forecast input series using CCC analysis, which is driven by the user-provided parameter. Similarly, the forecast and response summary engine 204 generates a summary of a plurality of standardized response input series using CCC analysis, also driven by the user-provided parameter. Additionally, as explained above, the user input engine 202 may receive a varied user-input parameter. In such a case, the forecast and response summary engine 204 updates the summaries of the plurality of forecast and response series based on the varied value of the user-provided input parameter.

The display engine 206 displays the summaries of the plurality of standardized forecast and response series. Additionally, as explained above, the user input engine 202 may receive a varied user-input parameter. In such a case, the forecast and response summary engine 204 updates the summaries of the plurality of forecast and response series based on the varied value of the user-provided input parameter and the display engine 206 displays the updated summaries accordingly.

A user of the collaborative inventory management forecast and response analysis system 200 is able to generate different summary views dynamically by varying the parameter that drives the CCC analysis. As will be explained in further detail below, varying the user-provided parameter alters the variance-correlation balance of the generated summaries, enabling the user to emphasize on different aspects of the forecast and response data in a dynamic manner. This additional flexibility increases the user's ability to critically analyze past forecasts and responses, which improves the user's ability to generate improved future forecasts or responses, as well as communicate with a buyer or supplier regarding supply- or demand-side problems.

Although not shown in FIG. 2, a forecasting engine may be employed to generate forecast and response input series for a participant in the collaborative inventory management system 200. Similarly, a standardization engine may be employed to standardize the forecast and response input series and store the resulting standardized forecast and response input series in the input series repository 208. Subsequently, as explained above, the forecast and response summary engine 204 may access the stored input series in the input series repository 208.

FIG. 3 shows another example of a collaborative inventory management forecast and response analysis system 300 in accordance with various implementations. The collaborative inventory management forecast and response analysis system 300 includes a memory resource 302 coupled to a processing resource 304. The processing resource 304 is one or more local or distributed processors. The memory resource 302 includes one or more local or distributed memory devices and comprises a user input module 306, a forecast and response summary module 308, and a display module 310. Thus, the memory resource 302 and the processing resource 304 are hardware components of the system 300.

Each module 306, 308, 310 represents instructions that, when executed by the processing resource 304, implements an associated engine. For example, when the user input module 306 is executed by the processing resource 304, the above-described user input engine 202 functionality is implemented. Similarly, when the forecast and response summary module 308 is executed by the processing resource 304, the above-described forecast and response summary engine 204 functionality is implemented. Further, when the display module 310 is executed by the processing resource 304, the above-described display engine 206 functionality is implemented. The modules 306, 308, 310 may also be implemented as an installation package or packages stored on the memory resource 302, which may be a CD/DVD or a server from which the installation package may be downloaded.

Turning now to FIGS. 4-6, examples of standardized input series, application of CCC analysis to standardized input series, and various examples of displays of summaries generated using CCC analysis are discussed in further detail. FIG. 4 shows the input series of FIG. 1 in standardized form. It is advantageous to standardize the input data before applying analysis methods, such as CCC.

For purposes of the following discussion, assume that the time interval to be analyzed is from period t to t+N and that forecasts made for these periods, one period ago, is denoted as the vector F₁:

$${F}_{1} = [ \begin{matrix}{f}_{t - 1 , t} \\ ⋮ \\ {f}_{t + N - 1 , t + N}\end{matrix} ]$$

Additionally, the forecasting horizon is given as M and thus there are M vectors of F to analyze, each vector providing the forecasts made for the time interval [t, t+N], made 1 . . . M periods ago. The matrix including these vectors is denoted as F:

$$F = [ \begin{matrix}{F}_{1} & ⋯ & {F}_{M}\end{matrix} ] = [ \begin{matrix}{f}_{t - 1 , t} & … & {f}_{t - M , t} \\ ⋮ & ⋱ & ⋮ \\ {f}_{t + N - 1 , t + N} & … & {f}_{t + N - M , t + N}\end{matrix} ]$$

A matrix of responses, R, is similarly defined.

Each input vector (Fᵢ and Rᵢ) is standardized by, for example, subtracting its mean and dividing the result by the vector's standard deviation, for example:

$${F}_{i}^{Adjusted} = \frac{{F}_{i} - mean ( {F}_{i} )}{std ( {F}_{i} )}$$

As shown in FIG. 4, it can be seen that variation trends are more aligned compared to FIG. 1, which allows subsequent analysis to capture the trends more accurately. Additionally, the correlation structure that may have been lost due to scale differences in FIG. 1 is preserved when using the standardized data of FIG. 4.

In accordance with various implementations, summary vectors F* and R* are linear combinations of vectors {F₁, . . . , F_{M}} and {R₁, . . . , R_{M}}, respectively:

F*=w₁*F₁+ . . . +w_{M}*F_{M}=F*w

R*=v₁*R₁+ . . . +v_{M}*R_{M}=R*v

Where w=[w₁ . . . w_{M}]^{T} and v=[v₁ . . . v_{M}]^{T}, ∥w∥=∥v∥=1. Ensuring that the weight vectors w and v have a norm of one, F* and R* are standardized linear combinations of F and R.

The vectors F* and R* contain summarized information relating to the variance and correlation of the full F and R matrices. The choice of linear combination vectors w and v depends on the type of information the user is seeking, which is coded in the CCC analysis using a user-provided parameter a (alpha). F* and R* are time series of length N+1, which is the same as the time series they are obtained from. F* and R* are series that summarize information contained in all the M raw time series. The members of vectors w and v determine which raw time series will have more or less weight in F* and R*.

Continuum canonical correlation (CCC) analysis enables a variable analysis, based on the user-provided parameter α, to control the amount of variance or correlation of the linear combination that results in the vectors F* and R*. The mathematical formula to be solved to obtain the linear combination vectors w and v is given as follows:

$$Maximize {( COV ( {F}^{*} , {R}^{*} ) )}^{2} {( VAR ( {F}^{*} ) * VAR ( {R}^{*} ) )}^{\frac{α}{1 - α} - 1}$$

$$subject to \text{:} ‖ w ‖ = 1 and ‖ v ‖ = 1$$

Where variation within F*, for example, is defined as:

VAR(F*)=VAR(F*w)=(F*w)^{T}(F*w)

Thus, CCC may be equivalently written as:

$$Maximize {( {( F * w )}^{T} * ( R * v ) )}^{2} {( {( F * w )}^{T} ( F * w ) * {( R * v )}^{T} ( R * v ) )}^{\frac{α}{1 - α} - 1}$$

$$subject to \text{:} ‖ w ‖ = 1 and ‖ v ‖ = 1$$

When α is equal to 1, the above formula reduces to Principal Component Analysis (PCA), which seeks find vectors w and v to maximize the variation within F* and R*. For example:

Maximize (F*w)^{T}(F*w) with respect to ∥w∥=1

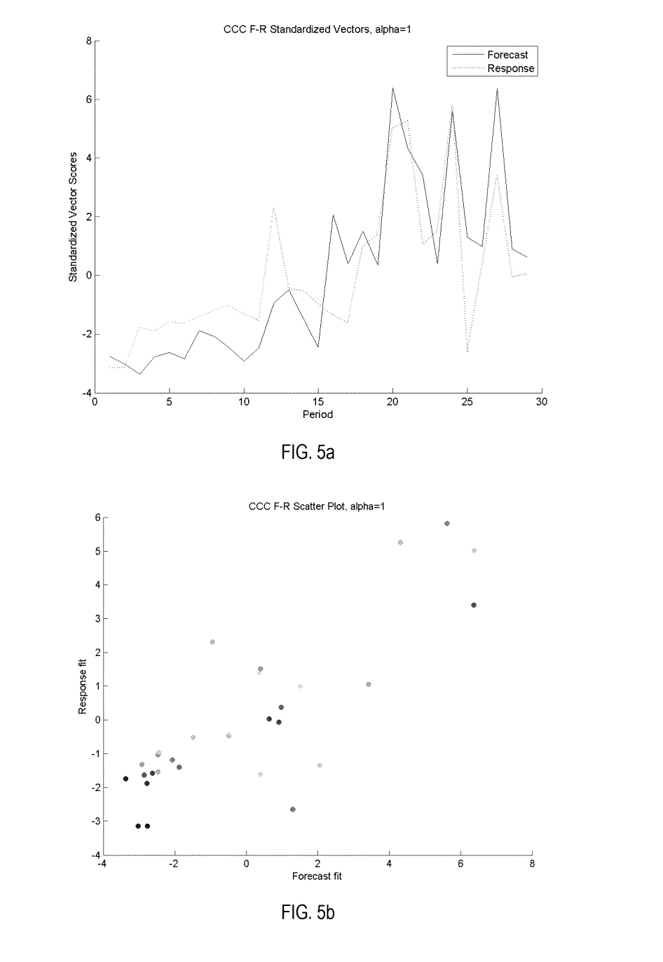

FIG. 5a shows an example of summary vectors F* and R* where vectors w and v have been selected to maximize variation (i.e., where α is equal to 1).

Similarly, when α is equal to 0, the CCC formula reduces to Canonical Correlation Analysis (CCA), which seeks to find vectors w and v to maximize the correlation between F* and R*. For example:

$$\frac{COV ( {F}^{*} , {R}^{*} )}{\sqrt{VAR ( {F}^{*} )} \sqrt{VAR ( {R}^{*} )}} = \frac{{( F * w )}^{T} * ( R * v )}{\sqrt{{( F * w )}^{T} ( F * w )} \sqrt{{( R * v )}^{T} ( R * v )}}$$

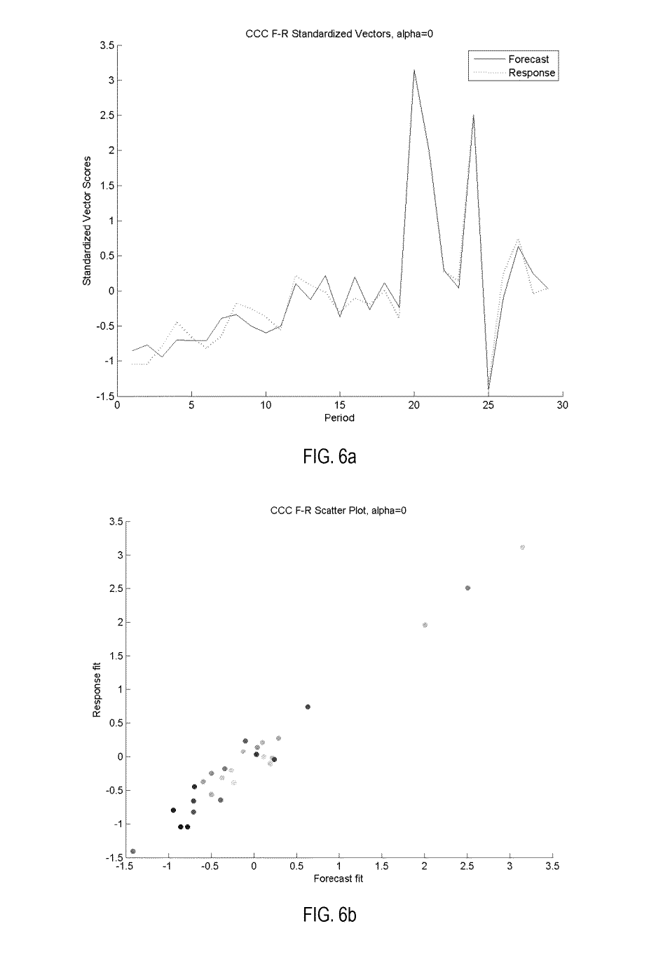

FIGS. 5b and 6b show alternate displays of the data shown in FIGS. 5a and 6a. In FIGS. 5b and 6b, a scatter plot is shown where each dot represents one period. The x-coordinate of each dot is its forecast summary vector value for that period. The y-coordinate of each dot is its response summary vector value for the same period. Periods are distinguished by the coloring of the dots; in the present example, a color range (e.g., a rainbow color range) is used to indicate which dot is associated with which period. Here, earlier periods are represented by dots toward the blue end of the color range whereas later periods are represented by dots toward the red end of the color range. At least in this example, no two dots have the same color so that the represented periods may be distinguished from one another.

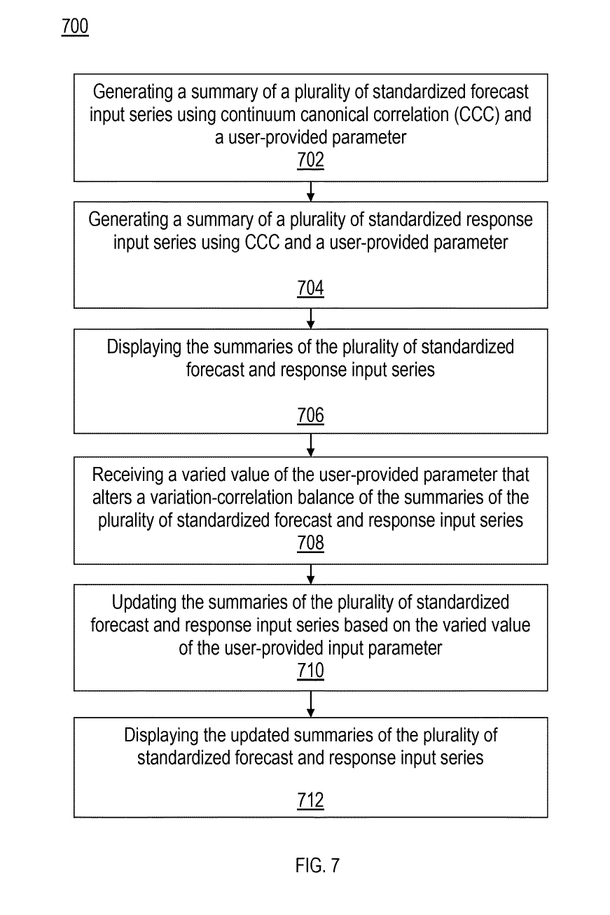

FIG. 7 shows a method 700 in accordance with various examples of the present disclosure. The method 700 begins in block 702 with generating a summary of a plurality of standardized forecast input series using continuum canonical correlation and a user-provided parameter, such as the user-provided parameter a explained above. The method 700 then continues in block 704 with generating a summary of a plurality of standardized response input series using continuum canonical correlation and the user-provided parameter. The input series may be standardized using methods similar to those described above. The method 700 continues in block 706 with displaying the summaries of the plurality of standardized forecast and response input series.

Next, the method 700 continues in block 708 with receiving a varied value of the user-provided parameter that alters a variation-correlation balance of the summaries of the plurality of standardized forecast and response input series. In some cases, the user-provided parameter a may be varied between 0 and 1 to emphasize correlation and variation, respectively, of the summary of the input series. The method also includes, in block 710, updating the summaries of the plurality of standardized forecast and response series based on the varied value of the user-provided parameter and, in block 712, displaying the updated summaries of the plurality of standardized forecast and response series. Although described sequentially, the above-described method steps 702-712 may be performed in varying order or, in some cases, simultaneously.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A collaborative inventory management forecast and response analysis system, comprising:
a forecast and response summary engine to:
generate a summary of a plurality of standardized forecast input series using continuum canonical correlation and a user-provided parameter;
generate a summary of a plurality of standardized response input series using continuum canonical correlation and the user-provided parameter; and
update the summaries of the plurality of standardized forecast and response series based on a varied value of the user-provided input parameter; and
a display engine to:
display the summaries of the plurality of standardized forecast and response series; and
display the updated summaries of the plurality of standardized forecast and response series.

2. The system of claim 1 further comprising a user input engine to receive the user-provided parameter and receive the varied value of the user-provided input parameter.

3. The system of claim 1 wherein the user-provided parameter comprises a value between and including 0 and 1.

4. The system of claim 1 further comprising a forecasting engine to generate the forecast and response input series and a standardization engine to standardize the forecast and response input series.

5. The system of claim 1 wherein the user-provided parameter being varied alters a variance-correlation balance of the summaries of the plurality of standardized forecast and response series.

6. The system of claim 1 wherein the display engine displays the summaries of the plurality of standardized forecast and response series as vector plots.

7. The system of claim 1 wherein the display engine displays the summaries of the plurality of standardized forecast and response series as scatter plots.

8. The system of claim 1 wherein the display engine is further configured to display the unstandardized forecast and response input series or to display the standardized forecast and response input series.

9. A method for analyzing forecasts and responses for collaborative inventory management, comprising:
generating a summary of a plurality of standardized forecast input series using continuum canonical correlation and a user-provided parameter;
generating a summary of a plurality of standardized response input series using continuum canonical correlation and the user-provided parameter;
displaying the summaries of the plurality of standardized forecast and response input series;
receiving a varied value of the user-provided parameter that alters a variation-correlation balance of the summaries of the plurality of standardized forecast and response input series;
updating the summaries of the plurality of standardized forecast and response series based on the varied value of the user-provided parameter; and
displaying the updated summaries of the plurality of standardized forecast and response series.

10. The method of claim 9 wherein the user-provided parameter comprises a value between and including 0 and 1.

11. The method of claim 9 further comprising generating the forecast and response input series and standardizing the forecast and response input series.

12. The method of claim 9 wherein varying the user-provided parameter alters a variance-correlation balance of the summaries of the plurality of standardized forecast and response series.

13. The method of claim 9 further comprising displaying the summaries of the plurality of standardized forecast and response series as vector plots.

14. The method of claim 9 further comprising displaying the summaries of the plurality of standardized forecast and response series as scatter plots.

15. The method of claim 9 further comprising displaying the unstandardized forecast and response input series or displaying the standardized forecast and response input series.

16. A non-transitory, computer-readable storage device storing software that, when executed by a processor, causes the processor to:
generate a summary of a plurality of standardized forecast input series using continuum canonical correlation and a user-provided parameter;
generate a summary of a plurality of standardized response input series using continuum canonical correlation and the user-provided parameter;
display, on a display device, the summaries of the plurality of standardized forecast and response input series;
receive a varied value of the user-provided parameter that alters a variation-correlation balance of the summaries of the plurality of standardized forecast and response input series;
update the summaries of the plurality of standardized forecast and response series based on the varied value of the user-provided parameter; and
display, on the display device, the updated summaries of the plurality of standardized forecast and response series.

17. The non-transitory, computer-readable storage device of claim 16 wherein the processor generates the forecast and response input series and standardizes the forecast and response input series.

18. The non-transitory, computer-readable storage device of claim 16 the user-provided parameter being varied causes the processor to alter a variance-correlation balance of the summaries of the plurality of standardized forecast and response series.

19. The non-transitory, computer-readable storage device of claim 16 wherein the processor displays the summaries of the plurality of standardized forecast and response series as vector plots.

20. The non-transitory, computer-readable storage device of claim 16 wherein the processor displays the unstandardized forecast and response input series or displays the standardized forecast and response input series.
